(19) United States
(12) Patent Application Publication
(10) Pub. No.: US 2013/0100248 A1
(43) Pub. Date: Apr. 25, 2013

(54) VIDEO TRANSMITTING APPARATUS AND VIDEO TRANSMITTING METHOD

(71) Applicant: Shinya Kadono, Hyogo (JP)

(72) Inventor: Shinya Kadono, Hyogo (JP)

(21) Appl. No.: 13/805,379

(22) PCT Filed: Mar. 28, 2012
(86) PCT No.: PCT/JP2012/002145

§ 371 Date: Dec. 19, 2012

(30) Foreign Application Priority Data
May 11, 2011 (JP) 2011-106446

(51) Int. Cl. H04N 7/26; H04N 13/00

(52) U.S. Cl. CPC H04N 7/26638; H04N 13/0059
USPC 348/43; 375/240.26

(57) ABSTRACT

A video transmitting apparatus includes: a video coder configured to compression-code a video signal to generate coded parameter information and coded pixel data; a supplemental information coder configured to code supplemental information for controlling display of a video to generate coded supplemental information; a coding unit multiplexing unit configured to output, in order, the coded parameter information and the coded supplemental information; and a stream transmitting unit configured to generate a coded stream which includes a packet including the coded parameter information and the coded supplemental information, using the data output from the coding unit multiplexing unit, and transmits the generated coded stream.

### TECHNICAL FIELD

The present invention relates to a video transmitting apparatus which transmits, for each packet unit, a stream obtained by compression-coding a video signal.

### BACKGROUND ART

Recently, high-speed network environments using Asymmetric Digital Subscriber Lines (ADSLs) or optical fibers have become popular, which makes it possible to communicate data with a bit rate exceeding several tens of Mega bits per second even at home.

It is expected that the use of image coding techniques according to MPEG-1, MPEG-2, MPEG-4, MPEG-4 AVC, H.264, and the like accelerates introduction of TV telephone systems and TV conference systems of TV broadcast quality or HDTV broadcast quality not only at enterprises which use exclusive lines but also at home.

Here, a video signal can be interpreted as a sequence of frames each made of a set of pixels having the same time. The pixels have a high correlation with the neighboring pixels within a frame. Thus, the pixel data is compressed utilizing the correlation between the pixels within the frame when compression-coding the video signal.

In addition, the pixels have a strong correlation in the sequence of frames, and thus the pixel data is also compressed utilizing the correlation between the pixels in the frames. The compression coding utilizing the correlation between the pixels within the frame and the correlation between the pixels in the frames are referred to as inter coding (for example, a P-frame is generated through this compression coding).

In addition, the compression coding utilizing the correlation between the pixels within the frame without utilizing the correlation between the pixels in the frames is referred to as intra coding (for example, an I-frame is generated through this compression coding).

Due to the utilization of inter-frame correlation, the inter coding provides a compression rate higher than that of the intra-coding.

In MPEG-1, MPEG-2, MPEG-4, MPEG-4 AVC, H.264 (see Non-patent literature 1), intra coding and inter coding are switched for each of blocks (or macroblocks) which is a set of pixels in a two-dimensional rectangular area.

A unit of one or more blocks is referred to as a slice which is the smallest transmission unit for coding or decoding the pixels accurately. One or more slices having the same time make up a frame.

The data compressed according to H.264 or the like is transmitted to a network for each unit called a packet. The data compressed according to H.264 or the like is generally transmitted to a network as packets which are Internet Protocol (IP) packets communicated using an IP network. Such IP packets are classified into a User Datagram Protocol (UDP) packet suitable for high-speed transmission and a Transmission Control Protocol (TCP) packet suitable for high-reliability transmission.

Furthermore, such IP packets include a Real-time Transport Protocol (RTP) packet generated by assigning temporal information to a UDP packet. RTP packets are generally used in the video transmission for transmitting a video signal having a large amount of data at high speed.

A method for storing, in RTP packets, data compressed according to H.264 and transmitting the RTP packets is disclosed in RFC3984 (Non-patent Literature 2).

### CITATION LIST

### Non Patent Literature

### [NPL 1]

ITU-T H.264, “Advanced video coding for generic audiovisual services”, March, 2010

### [NPL 2]

RFC3984, “RTP Payload Format for H.264 VIDEO”, February, 2005

### SUMMARY OF INVENTION

### Technical Problem

Recently, 3D (three-dimensional) videos have been given attention, and 3D video broadcasts have been started in digital broadcasting. The streams including 3D video data for use in such 3D video broadcasts must include information such as identification information for identifying, for example, whether each of the stream portions is 2D or 3D. As such, a technique for efficiently transmitting such streams is required.

The present invention has been made in view of the aforementioned problem, with an aim to provide a video transmitting apparatus and a video transmitting method for generating and transmitting a coded stream having a high error resilience while suppressing increase in the amount of data of the coded stream.

### Solution to Problem

In order to solve the aforementioned problem, a video transmitting apparatus according to an aspect of the present invention includes: a video coder configured to compression-code a video signal to generate coded parameter information and coded pixel data, the coded parameter information being parameter information commonly used to decode slices included in at least one picture, and the coded pixel data being of the picture; a supplemental information coder configured to code supplemental information for controlling display of a video represented by the video signal to generate coded supplemental information; a coding unit multiplexing unit configured to output, in order predetermined for each of coding units, the coded parameter information generated by the video coder and the coded supplemental information generated by the supplemental information coder; and a stream transmitting unit configured to generate a coded stream including a packet which includes the coded parameter information and the coded supplemental information, using data output from the coding unit multiplexing unit, and transmit the generated coded stream.

It is to be noted that a general or specific aspect may be implemented in the form of a system, a method, an integrated circuit, a computer program, or a recording medium, or by combining any of a system, a method, an integrated circuit, a computer program, and a recording medium.

### Advantageous Effects of Invention

According to the present invention, it is possible to provide a video transmitting apparatus and a video transmitting method for generating and transmitting a coded stream having a high error resilience while suppressing increase in the amount of data of the coded stream.

### BRIEF DESCRIPTION OF DRAWINGS

FIG. 1 is a diagram showing an exemplary stream structure of video data according to Embodiment 1 of the present invention.

FIG. 2 is a diagram showing first exemplary RTP packet structures according to Embodiment 1 of the present invention.

FIG. 3 is a block diagram showing an exemplary functional structure of a video transmitting apparatus according to Embodiment 1 of the present invention.

FIG. 4 is a flowchart showing a basic flow of processes performed by the video transmitting apparatus according to Embodiment 1 of the present invention.

FIG. 5 is a first flowchart of processes of a video coding method according to Embodiment 1 of the present invention.

FIG. 6 is a second flowchart of processes of the video coding method according to Embodiment 1 of the present invention.

FIG. 7 is a flowchart of processes of an RTP packet generating scheme according to Embodiment 1 of the present invention.

FIG. 8 is a diagram showing second exemplary RTP packet structures according to Embodiment 1 of the present invention.

FIG. 9 is a diagram showing third exemplary RTP packet structures according to Embodiment 1 of the present invention.

FIG. 10A is a schematic diagram showing a video into which two videos are synthesized.

FIG. 10B is a schematic diagram of a video 1 among the two videos shown in FIG. 10A which is extracted and displayed.

FIG. 10C is a schematic diagram of a video 2 which is extracted and displayed among the two videos shown in FIG. 10A.

FIG. 11 is a diagram showing an exemplary data structure of part of SEI as position information according to Embodiment 1 of the present invention.

FIG. 12 includes illustrations of a recording medium and a computer system according to Embodiment 2 of the present invention.

FIG. 13 includes diagrams for explaining a 2D/3D identification scheme and 2D/3D identification information items conventionally used.

FIG. 14 is a diagram showing an exemplary stream structure of a conventional 2D video data.

FIG. 15 is a diagram showing an exemplary stream structure of a conventional 3D video data.

FIG. 16 is a diagram showing conventional exemplary RTP packet structures.

FIG. 17 is a block diagram showing an exemplary functional structure of a conventional video receiving apparatus.

FIG. 18 is a block diagram showing an exemplary functional structure of a conventional video transmitting apparatus.

### DESCRIPTION OF EMBODIMENTS

### Underlying Knowledge Forming Basis of the Present Invention

The inventor found a later-described problem regarding a technique of generating a stream including 3D video data and transmitting the generated stream.

Recently, as mentioned above, 3D videos have drawing the attention, and 3D video broadcasts have been started in digital broadcasting. 2D broadcast receivers have already become popular in digital broadcasting, and thus it is important to employ a 3D scheme obtainable by little modifying a scheme used in a current 2D broadcast receiver.

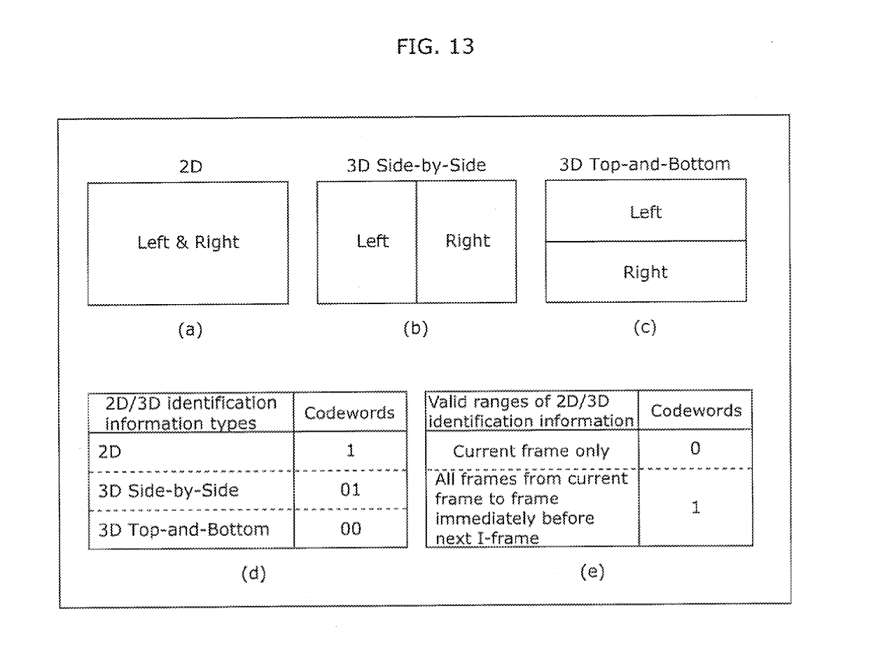

For this reason, 3D broadcasting is realized by storing the number of horizontal pixels and the number of vertical pixels of a video signal and a frame rate in the same frame as in 2D broadcasting. A specific realization approach is described using 2D/3D identification information and 2D/3D identification information valid ranges shown in FIG. 13.

In FIG. 13, (a) is an image in a conventional 2D broadcasting. In the case of such a 2D image, the image serves as both an image for a left eye and an image for a right eye.

In digital broadcasting, the numbers of horizontal pixels in the left- and right-eye images are reduced to the half of a 2D image. The left half and the right half in (b) of FIG. 13 are transmitted as the left-eye image and the right-eye image, respectively. This transmission scheme is referred to as a 3D side-by-side scheme.

In the 3D side-by-side scheme, the number of horizontal pixels and the number of vertical pixels of the synthesized image in (b) of FIG. 13 are the same as in the conventional 2D image in (a) of FIG. 13. Thus, the 3D side-by-side scheme provides an advantageous effect of being able to use most of broadcasting apparatuses for 2D images without any modifications.

When the image in (b) of FIG. 13 is displayed on a display screen, the left half is doubled horizontally to have the same number of pixels as in the 2D image in (a) of FIG. 13, and is displayed as the left-eye image. Likewise, the right half of the image is doubled horizontally to have the same number of pixels as in the 2D image in (a) of FIG. 13 and is displayed as the right-eye image.

In addition, it is possible to use the upper half and the lower half in (c) of FIG. 13 as a left-eye image and a right-eye image, respectively although such usage has not yet been introduced in broadcasting. This transmission scheme is referred to as a 3D top-and-bottom scheme.

When any one of the video signals in (a), (b), and (c) of FIG. 13 is displayed on the display screen, it is necessary to identify the transmission scheme used for the video signal, and display the left-eye image and the right-eye image in an appropriately separated manner as described above.

For this reason, as shown in (d) of FIG. 13, 2D/3D identification information for identifying one of 2D, 3D side-by-side, and 3D top-and-bottom has been conventionally multiplexed in the form of a codeword into a stream. The stream obtained in this way is transmitted from a video transmitting apparatus to a video receiving apparatus.

In addition, the 2D/3D identification information may be assigned for each frame unit so as to be valid in the frame. The 2D/3D identification information may be assigned for each I-frame unit (which is made up of frames starting with a frame having the 2D/3D identification information and ending with a frame immediately before the next I-frame) referred to as group of pictures (GOP) so as to be valid within the GOP.

Here, in order to show the valid range of the 2D/3D identification information, as shown in (e) of FIG. 13, the valid range of the 2D/3D identification information is multiplexed in the form of a codeword into the stream, and is transmitted with the 2D/3D identification information from the video transmitting apparatus to the video receiving apparatus.

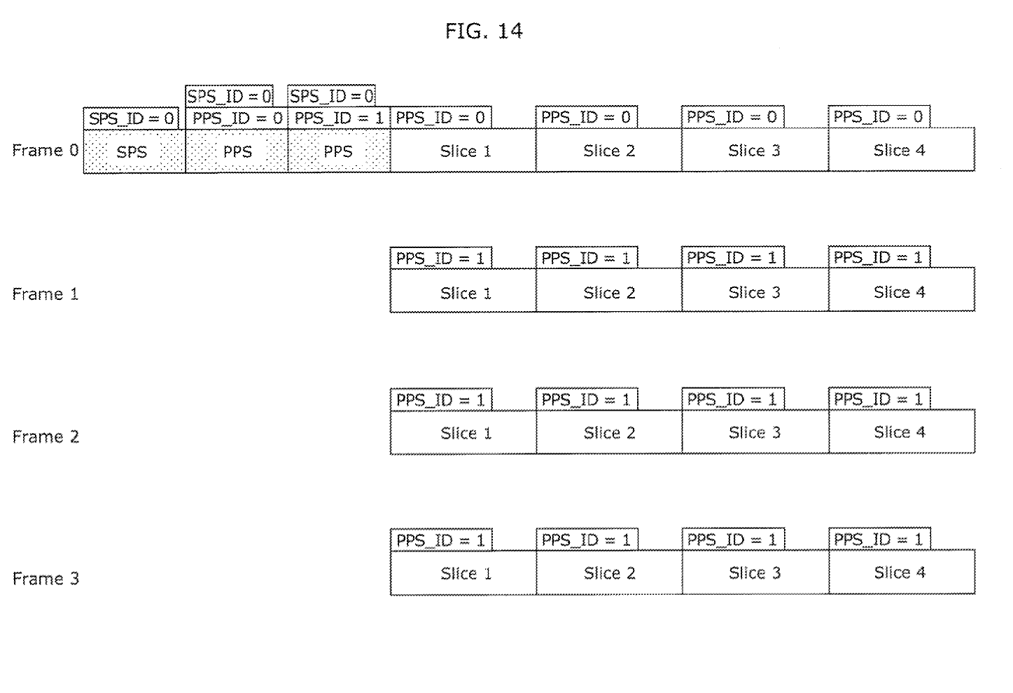

FIG. 14 is a diagram showing an exemplary stream structure of a conventional 2D video data.

As shown in FIG. 14, the pixels of a frame are coded on a per slice unit basis, and a plurality of slices make up the frame. Here, the starting frame includes information items which are commonly referred to in the coding and decoding of a plurality frames. These information items are referred to as a sequence parameter set (SPS) and a picture parameter set (PPS), respectively.

An SPS includes SPS_ID, and a PPS includes SPS_ID and PPS_ID. Furthermore, each slice includes PPS_ID for identifying the PPS and SPS to be referred to in the coding and decoding.

The PPS having the same PPS_ID as the PPS_ID included in the slice is referred to in the coding and decoding of the slice. Furthermore, the SPS having the same SPS_ID as the SPS_ID included in the PPS is referred to in the coding and decoding of the slice.

In this way, in the coding and decoding of the frames, the SPS and PPS that should be referred to in the coding and decoding of each slice can be identified from among the SPSs and PPSs of the slices.

For example, in FIG. 14, each of the slices of Frame 0 has PPS_ID of “0”. This shows that the starting PPS having PPS_ID=0 in Frame 0 is referred to in the coding and decoding of the slice. Likewise, each of the slices of Frames 1 to 3 has PPS_ID of “1”. This shows that the second PPS having PPS_D=1 in Frame 0 is referred to in the coding and decoding of the slice.

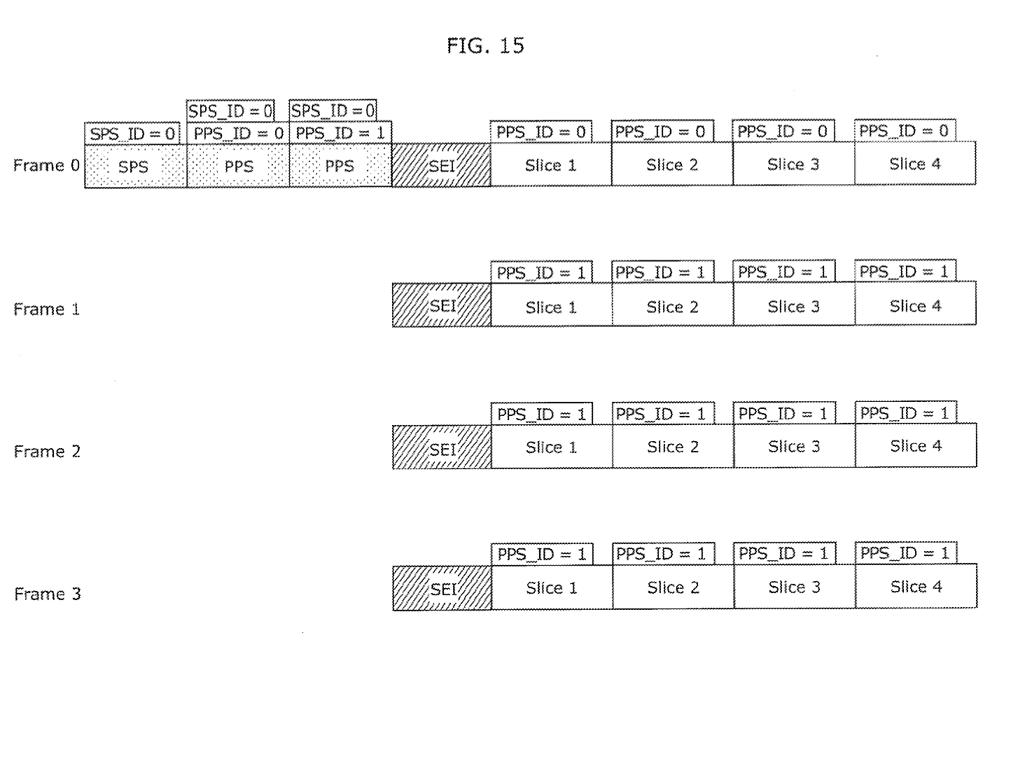

FIG. 15 is a diagram showing an exemplary stream structure of a conventional 3D video data.

In the Japanese digital broadcasting, the stream structure shown in FIG. 15 is used as the stream structure for 3D video data.

The exemplary conventional 3D video data shown in FIG. 15 is different from the exemplary conventional 2D video data shown in FIG. 14, in stream structure specifically in that the conventional 3D video data stream has supplemental information referred to as supplemental enhancement information (SEI).

The SEI is unnecessary in video coding and decoding processes, but is useful information in the coding and decoding system. The 2D/3D identification information and the information indicating the valid range of the 2D/3D identification information in (d) and (e) of FIG. 13 correspond to the SEI.

Examples of SEI include SEI indicating that a stream can be decoded and reproduced starting with a frame having the SEI, and SEI indicating a recommended amount of data to be stored in a reception buffer during a period between when a stream is received and when the decoding of the stream is started.

Assigning SEI to each frame makes it possible to prevent that 2D/3D identification of a plurality of frames fails sequentially when a packet including SEI is lost in the transmission of a stream through a network because the packet loss only disables 2D/3D identification of the frame corresponding to the SEI in the lost packet.

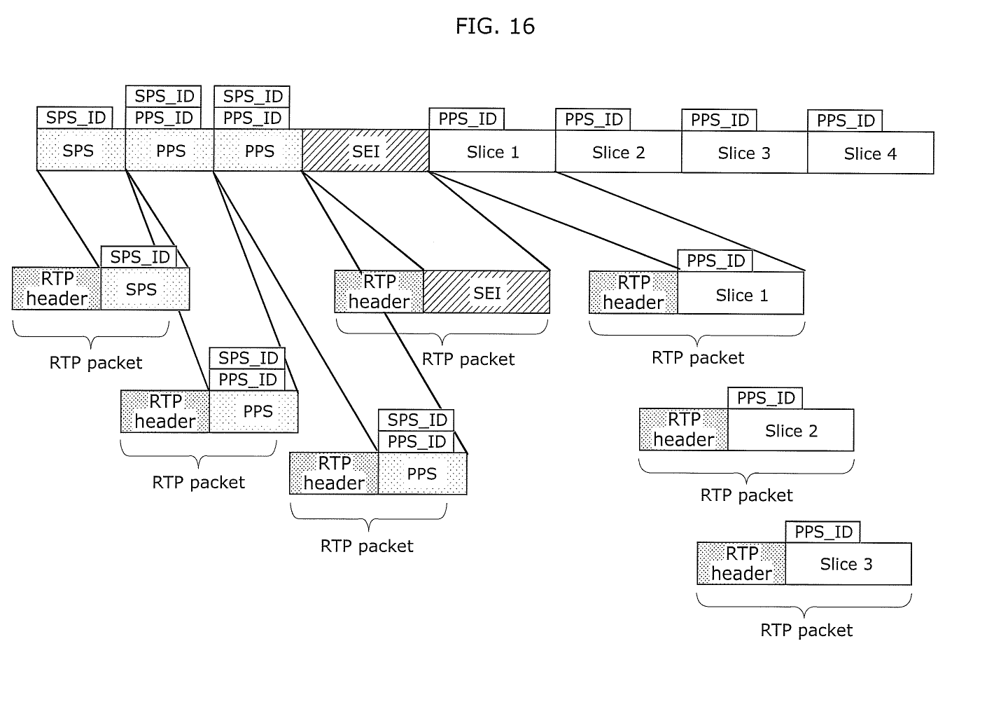

FIG. 16 is a diagram showing conventional exemplary RTP packet structures.

As shown in FIG. 16, an RTP packet which is a transmission unit in a network is made to include one of (i) a slice used as a coding and decoding unit, and (ii) an SPS or a PPS either of which is a unit of information to be commonly referred to in the coding and decoding of a plurality of frames.

The use of such an RTP packet reduces the influence of an RTP packet loss when the RTP packet is lost in the transmission through the network because only the coding and decoding unit data is lost.

If a signal RTP packet includes a plurality of slices, SPSs or PPSs, the loss of the RTP packet disables proper decoding of the plurality of slices, SPSs or PPSs, resulting in a significant deterioration in the image quality of the decoded video.

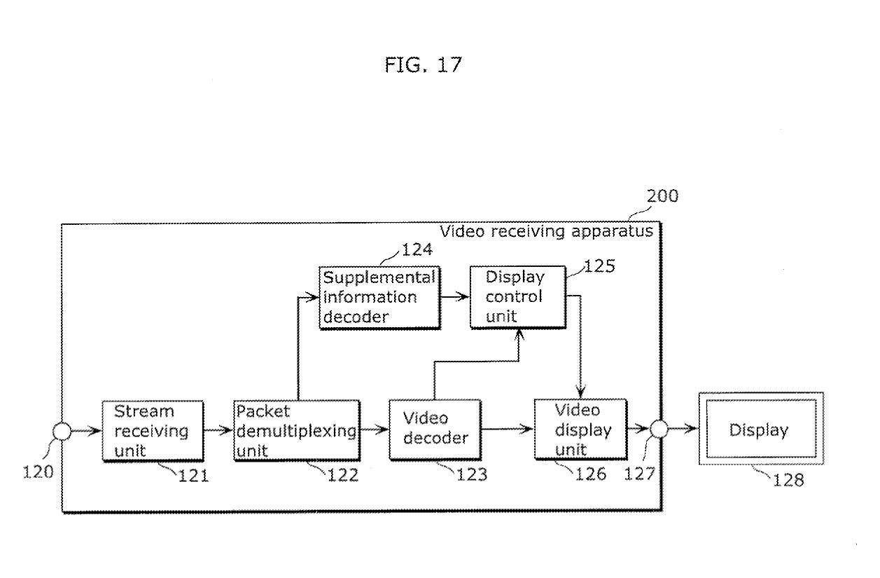

FIG. 17 is a block diagram showing an exemplary functional structure of a conventional video receiving apparatus.

The conventional video receiving apparatus 200 shown in FIG. 17 includes an input terminal 120, a stream receiving unit 121, a packet demultiplexing unit 122, a video decoder 123, a supplemental information decoder 124, a display control unit 125, a video display unit 126, and a video output terminal 127. In addition, to the video receiving apparatus 200, a video display device 128 is connected via a video output terminal 127.

The coded stream input through the input terminal 120 is received by the stream receiving unit 121, and packets from which RTP headers have been removed are input to the packet demultiplexing unit 122. The packet demultiplexing unit 122 inputs, to the video decoder 123, packets (each of which is an SPS, a PPS, or a slice) necessary for decoding the video, and inputs, to the supplemental information decoder 124, packets including SEI) necessary for display of the video.

The video decoder 123 decodes the packets necessary for decoding the video input from the packet demultiplexing unit 122, and inputs the decoded video to the video display unit 126. Furthermore, the video decoder 123 notifies the display control unit 125 of the completion of the decoding of the frames.

The supplemental information decoder 124 decodes the packets having the information necessary for displaying the video input from the packet demultiplexing unit 122, and notifies the display control unit 125 of the 2D/3D display mode.

The display control unit 125 determines whether or not each of the decoded frames is 2D or 3D, and notifies the video display unit 126 of the display mode which is 2D or 3D.

Here, each of the decoded frames and the information necessary for displaying the video are associated with each other by associating frame numbers with the packets output from the packet demultiplexing unit 122 to the supplemental information decoder 124 or counts the number of frame boundary information items output from the packet demultiplexing unit 122 to the supplemental information decoder 124.

Based on an instruction by the display control unit 125, the video display unit 126 outputs the decoded video from the video output terminal 127 and causes the video display device 128 to display the video.

When the video display device 128 supports 3D display, the video display unit 126 assigns, as control information for the video display device 128, video storage format information (see (a) to (c) of FIG. 13) decoded by the supplemental information decoder 124 for the unmodified video frames decoded by the video decoder 123. Furthermore, the video display unit 126 inputs the video to the video display device 128. In this way, the video display device 128 can automatically determine whether each frame is 2D or 3D and appropriately display the frame.

When the coded stream input through the input terminal 120 is a 3D video and the video display device 128 does not support 3D display, the video display unit 126 enlarges only the left-eye part as shown in (b) or (c) of FIG. 13 of the video decoded by the video decoder 123 to have a size corresponding to one frame, and inputs the frame to the video display device 128. In this way, the video display device 128 can appropriately display the frame.

When the coded stream input through the input terminal 120 is a 2D video, it is only necessary that the video frames decoded by the video decoder 123 are input to the video display device 128, and the video display device 128 can accurately display the 2D video.

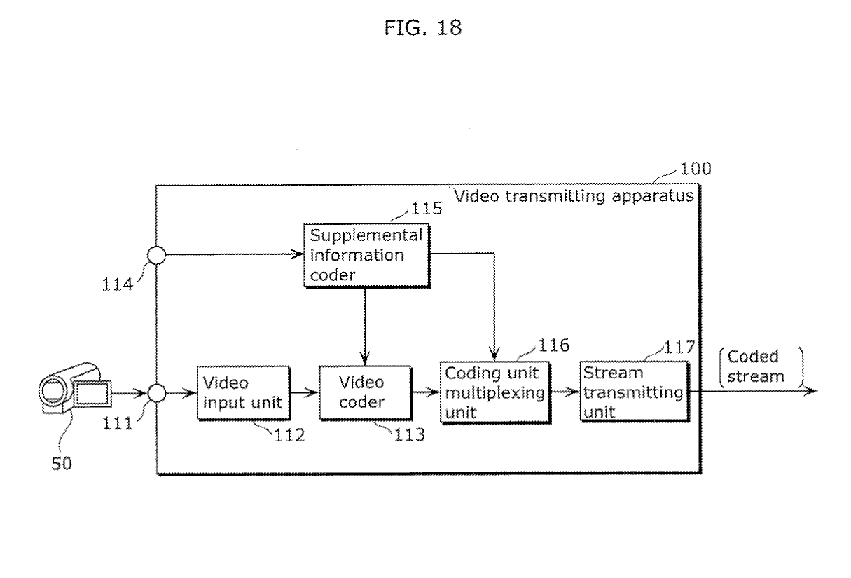

FIG. 18 is a block diagram showing an exemplary functional structure of a conventional video transmitting apparatus.

The conventional video transmitting apparatus 100 shown in FIG. 18 includes a video input unit 112, a video coder 113, a supplemental information coder 115, a coding unit multiplexing unit 116, and a stream transmitting unit 117.

The video signal generated by the video imaging device 50 is input to the video input unit 112 via the video input terminal 111. The video input unit 112 performs image processing such as removal of noise included in the video signal, and inputs the video signal to the video coder 113. The video coder 113 compression-codes the output data from the video input unit 112, and outputs the coded data to the coding unit multiplexing unit 116.

The 2D/3D identification information indicating whether the video signal output from the video imaging device 50 to the video input terminal 111 and the information indicating frame storage formats (see (a) to (c) of FIG. 13) in the case of a 3D video are input from the supplemental information input terminal 114.

These information items including 2D/3D identification information input to the supplemental information input terminal 114 may be automatically obtained from the video imaging device 50 or may be exclusively specified by a user.

These information items including 2D/3D identification information input to the supplemental information input terminal 114 is coded by the supplemental information coder 115, and is input to the coding unit multiplexing unit 116. The coding unit multiplexing unit 116 rearranges the output data from the video coder 113 and the output data from the supplemental information coder 115 in the data order as shown in FIG. 15, and inputs the rearranged data to the stream transmitting unit 117. The stream transmitting unit 117 configures the output data from the coding unit multiplexing unit 116 as RTP packets as shown in FIG. 16 to generate a coded stream made up of the RTP packets.

Here, when SEI is included in each frame as shown in FIG. 15, the bit rate must be increased by the amount corresponding to the amount of data of the SEI, compared to the case where SEI is not included in each frame. For this reason, the increase in the amount of data of SEI cannot be ignored in a low bit rate environment, and thus the bit rate must be increased.

In addition, even in a high bit rate environment in which such increase in the amount of data of SEI can be ignored, when a packet including SEI is lost in a network, the frame(s) corresponding to the SEI is decoded and displayed based on erroneous 2D/3D identification. This results in a problem that the image quality of the frame deteriorates.

In order to solve the aforementioned problem, a video transmitting apparatus according to an aspect of the present invention includes: a video coder configured to compression-code a video signal to generate coded parameter information and coded pixel data, the coded parameter information being parameter information commonly used to decode slices included in at least one picture, and the coded pixel data being of the picture; a supplemental information coder configured to code supplemental information for controlling display of a video represented by the video signal to generate coded supplemental information; a coding unit multiplexing unit configured to output, in order predetermined for each of coding units, the coded parameter information generated by the video coder and the coded supplemental information generated by the supplemental information coder; and a stream transmitting unit configured to generate a coded stream including a packet which includes the coded parameter information and the coded supplemental information, using data output from the coding unit multiplexing unit, and transmit the generated coded stream.

With this structure, a packet including the supplemental information for display control of the video and the parameter information corresponding to the video is generated, and the coded stream including the packet is transmitted.

For this reason, when the supplemental information is lost in the transmission of the coded stream, the parameter information is surely lost. As a result, the video receiving apparatus which receives and decodes the coded stream cannot decode the video, and thus can reliably detect the loss of the supplemental information.

In other words, the video transmitting apparatus according to this aspect allows the video receiving apparatus to recognize the loss of the supplemental information which is display control information and thus is not essential to the decoding process. For this reason, the video receiving apparatus can execute appropriate display using the supplemental information.

In addition, since the video transmitting apparatus allows the video receiving apparatus to recognize the loss of the supplemental information, the video transmitting apparatus can recover display error due to the loss of the supplemental information at an early stage even in an exemplary case where such supplemental information is not assigned to each of plural pictures.

In this way, the video transmitting apparatus according to this aspect can suppress increase in the amount of data, and can generate and transmit a coded stream having a high error resilience.

In addition, for example, the supplemental information may indicate whether the video represented by the video signal is a first video or a second video, the first video and the second video having different display modes, and the video coder may be configured to generate the coded parameter information and the coded pixel data which have a first identifier assigned, when the video signal is the first video; and generate the coded parameter information and the coded pixel data having a second identifier assigned, when the video signal represents the second video, the second identifier being different from the first identifier.

With this structure, in the cases where the display mode of the video represented by the video signal is changed, the identifier assigned commonly to the coded parameter information and the coded pixel data are changed.

Here, the cases where the display mode of the video represented by the video signal is changed includes: a case where the video is switched from 2D to 3D; a case where the resolution of the video is changed; and a case where a normal video signal of a single video is switched to a video signal of a plurality of videos displayed in parallel.

In other words, the identifier for identifying the parameter information to be used in the decoding of the coded pixel data is changed before and after the change of the display mode of the video. For this reason, in an exemplary case where the parameter information corresponding to a second video is lost in the transmission, there is no possibility that the video receiving apparatus erroneously refers to the parameter information corresponding to a previously-received first video in the decoding process for obtaining the second video. As a result, it is possible to prevent that the second video is displayed in a mode different from the proper display mode.

In addition, for example, the supplemental information may indicate whether the video represented by the video signal is a first video or a second video, the first video and the second video having different display modes, when the video represented by the video signal is switched from one of the first video and the second video to the other, the supplemental information coder may be configured to generate coded supplemental information indicating the other of the first video and the second video, and the video coder may be configured to generate the coded parameter information, when the coded supplemental information indicating the other of the first video and the second video is generated.

With this structure, the coded parameter information is generated when the coded supplemental information is generated or updated. As a result, a packet is generated which includes the generated or updated coded supplemental information and the coded parameter information.

In this way, when the display mode of the video represented by the video signal is changed, the supplemental information according to the change is reliably communicated to the video receiving apparatus.

In addition, for example, the stream transmitting unit may be configured to generate, for each of sequences of a plurality of pictures represented by the video signal, the coded stream including the packet which includes the coded parameter information and the coded supplemental information corresponding to the plurality of pictures.

With this structure, the supplemental information is assigned for each of the sequences of the plurality of pictures. For this reason, it is possible to suppress increase in the amount of data of the whole coded stream.

In addition, for example, the supplemental information may be identification information indicating that a display mode of the video represented by the video signal is 3D.

With this structure, even when the supplemental information indicating that the video signal included in the coded stream is 3D is lost in the transmission, the video receiving apparatus can reliably detect the loss of the supplemental information. For this reason, it is possible to prevent that the video signal is reproduced and displayed as a 2D video.

In addition, for example, a display mode of the video represented by the video signal may be three-dimensional (3D), and the supplemental information may be identification information for identifying a transmission scheme for the video signal.

With this structure, even when the supplemental information indicating that the video signal included in the coded stream is 3D is lost in the transmission, the video receiving apparatus can reliably detect the loss of the supplemental information. For this reason, it is possible to prevent that the video signal is erroneously displayed in a mode according to the other transmission scheme.

In addition, for example, the video signal may be a signal representing at least two videos which can be displayed in parallel in a frame area, and the supplemental information may be position information indicating positions of the at least two videos in the frame area.

With this structure, the video receiving apparatus which receives the coded stream can extract each of the two or more videos, based on the information shown in the supplemental information.

In addition, since the loss of the supplemental information is reliably detected when the supplemental information is lost in the transmission, it is possible to prevent that the video signal including the two or more videos is reproduced and displayed in the same manner as for a normal video signal representing only a video.

In addition, for example, the video coder may be configured to generate the coded parameter information when at least one of the number of horizontal pixels and the number of vertical pixels of the video represented by the video signal is changed.

With this structure, when the resolution of the video represented by the video signal is changed, it is possible to store, in a packet, the coded parameter information corresponding to the video that should be displayed at the after-change resolution and the coded supplemental information, and transmit the packet.

In addition, for example, the parameter information may include at least one of a sequence parameter set (SPS) and a picture parameter set (PPS).

With this structure, when the supplemental information is lost in the transmission of the coded stream, at least one of the SPS and PPS necessary for decoding the coded pixel data corresponding to the supplemental information is surely lost. As a result, the video receiving apparatus which receives and decodes the coded stream can reliably detect the loss of the supplemental information.

It is to be noted that a general or specific aspect may be implemented in the form of a system, a method, an integrated circuit, a computer program, or a recording medium, or by combining any of a system, a method, an integrated circuit, a computer program, and a recording medium.

Hereinafter, embodiments of the present invention are described with reference to the drawings.

Each of the exemplary embodiments described below shows a general or specific example. The numerical values, shapes, materials, structural elements, the arrangement and connection of the structural elements, steps, the processing order of the steps etc. shown in the following exemplary embodiments are mere examples, and therefore do not limit the present invention. Therefore, among the structural elements in the following exemplary embodiments, structural elements not recited in any one of the independent claims defining the most generic inventive concept are described as arbitrary structural elements.

### Embodiment 1

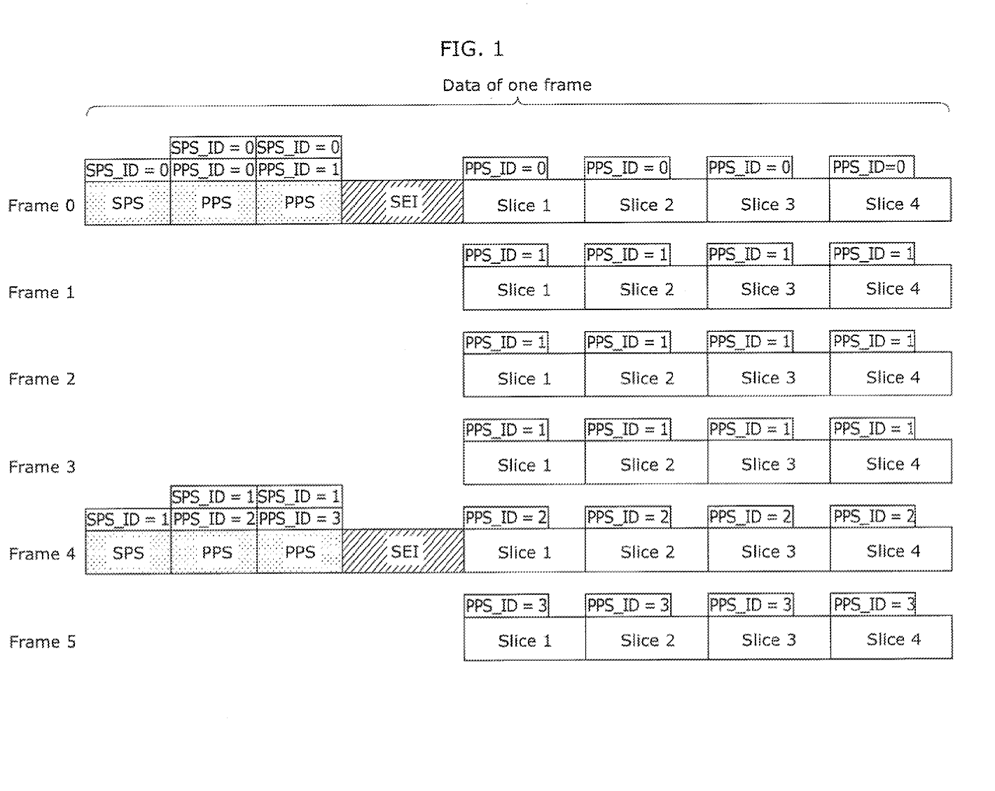

FIG. 1 is a diagram showing an exemplary stream structure of video data according to Embodiment 1 of the present invention.

The stream shown in FIG. 1 includes SEI assigned only to its starting frame, which is a large difference from the stream shown in FIG. 15. In short, the stream in this embodiment includes SEI assigned or each of sequences.

Here, SEI is exemplary supplemental information for display control of a video represented by a video signal.

In addition, the “frame” in this embodiment is, for example, a frame that is a picture in a progressive image. In addition, the “frame” in this embodiment may be a picture which is a frame or field in an interlace image.

FIG. 1 shows a stream structure including Frames 0 to 3 which can be displayed based on an SEI item, and including Frames 4 and 5 which can be displayed based on another SEI item. The SEI is assigned to the starting one of the frames for which the SEI can be used.

Here, for convenience of enabling starting point search when recording and reproducing a stream to be transmitted in a network onto a storage medium, an I-frame is disposed as the starting frame in many cases so as to enable decoding of the frame at which 2D and 3D is switched.

Accordingly, it is desirable that SEI should be assigned to such an I-frame. In FIG. 1, Frames 0 to 3 and Frames 4 and 5 have different SPS_ID and PPS_JD. In other words, the SPS_ID and PPS_ID assigned to Frames 0 to 3 are different from the SPS_ID and PPS_ID assigned to Frames 4 and 5.

When this stream is transmitted via a network according to a conventional method, the loss of an SEI item is problematic because the error causes erroneous 2D/3D identification of a plurality of frames.

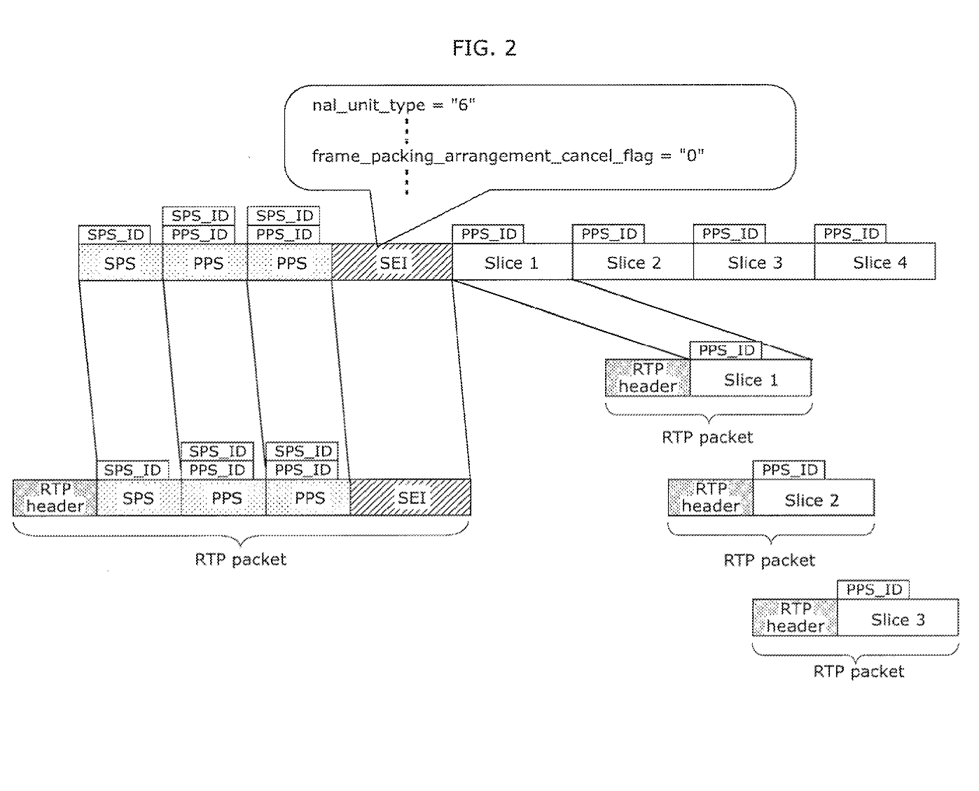

For this reason, in this embodiment, each SEI item is included together with at least one of an SPS and a PPS in an RTP packet as in the exemplary RTP packet structures according to Embodiment 1 of the present invention as shown in FIG. 2, instead of making a coding unit as an RTP packet.

Each of SPSs and PPSs is an example of parameter information to be used commonly for decoding the slices included in at least one picture.

FIG. 2 shows an exemplary data structure of a type of SEI including 2D/3D identification information (SEI as a 2D/3D identifier), More specifically, in H.264, “nal_unit_type=“6”” shows that the information is SEI, and “frame_packing_arrangement_cancel_flag=“0”” shows that the display mode of the video represented by the video signal corresponding to the SEI is 3D.

In other words, the SEI as the 2D/3D identifier is an example of supplemental information indicating the video represented by the video signal is one of a 2D video (first video) and a 3D video (second video) which have mutually different display modes.

The information indicating the applicable range (for example, this frame only) for the SEI is also included in the SEI as described earlier although the information is not shown in FIG. 2. In addition, the identification information for identifying the transmission scheme (such as the 3D side-by-side scheme) of the video signal is also included in the SEI.

Since any information loss in a network occurs on a per packet basis, in the present invention, when an SEI item is lost, at least a corresponding one of an SPS and a PPS is also lost.

In general, video transmitting apparatuses and video receiving apparatuses support a method robust to packet losses assuming that packets may be lost in networks. For example, a two-stage method is generally used.

(1) The pixel values corresponding to the lost packet are predicted by the video decoder, and the video decoding is continued by using the pixel values predicted and generated as the pixel values corresponding to the lost packet.

(2) When a serious error which cannot be recovered using the above stage (1) is detected by the video decoder, the video receiving apparatus issues, to the video transmitting apparatus, an instruction for coding the next frame as an I-frame for which inter frame prediction is not used. Upon receiving the instruction, the video transmitting apparatus codes and transmits the next frame as the I-frame.

The video receiving apparatus temporarily stops displaying the video until the I-frame is received. In this way, it is possible to prevent a display error due to a frame decoded based on an erroneous interpretation or display of a frame erroneously interpreted.

The aforementioned conventional two-stage method is one of countermeasures against packet losses in networks.

Even when SEI is lost in a conventional video transmitting apparatus, a video receiving apparatus cannot recognize what information is lost but does not have any problem in the decoding process without the SEI.

In other words, when SEI is lost, the stage (1) of pixel value processing in the aforementioned method is not performed. When the received stream does not include any SEI as a 2D/3D identifier which is supplemental information for display control, the stream is regarded as a stream of a normal 2D video signal, and thus the stage (2) of pixel value processing in the aforementioned method is not performed.

As a result, the conventional video receiving apparatus cannot detect the loss of SEI, and thus make erroneous 2D/3D identification of a plurality of frames.

In contrast, in this embodiment, the PPS_ID assigned to each 2D frame and the PPS_ID assigned to each 3D frame are different from each other.

Here, in the video receiving apparatus, the video decoder decodes the data of a slice by referring to the PPS identified by the PPS_ID included in the slice. However, in this embodiment, since an SEI and a PPS are included in a packet and transmitted, the PPS is lost when the SEI is lost.

In other words, since the PPS is lost when the SEI is lost, there is no PPS (the PPS identified by the PPS_ID included in the slice) necessary for decoding the slice corresponding to the SEI.

In other words, since there is no PPS that should be referred to in the decoding of the slice, the slice cannot be decoded at all. As a result, the stage (2) of the method is performed, and the video transmitting apparatus transmits the frame (I-frame) Upon receiving this, the video receiving apparatus can decode and display the frame correctly.

In this way, by employing the stream structure in this embodiment as the stream structure of a video signal in which 2D and 3D are switched, it is possible to prevent a sequence of 2D and 3D frames in the stream from being erroneously identified, and the sequence of frames and the subsequent frames in the stream from being decoded and displayed based on the erroneous identification.

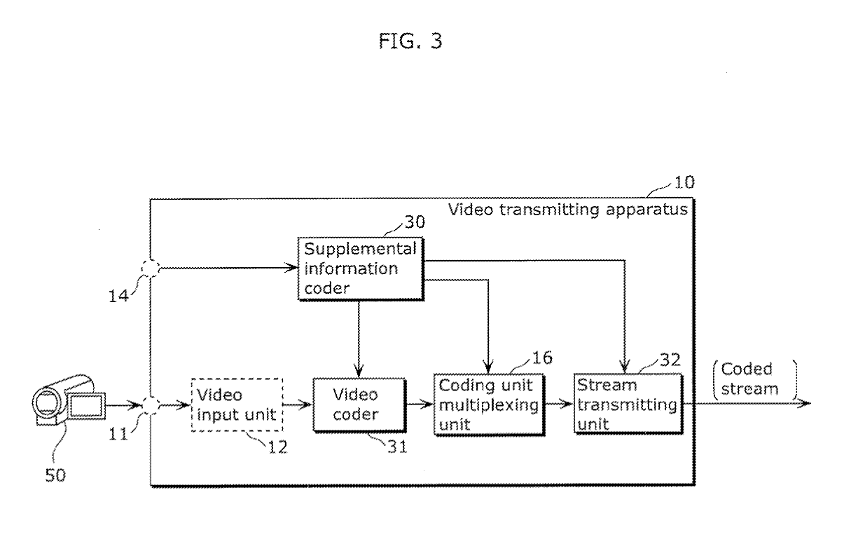

FIG. 3 is a block diagram showing an exemplary functional structure of a video transmitting apparatus 10 according to Embodiment 1 of the present invention.

The video transmitting apparatus 10 includes a video input unit 12, a video coder 31, a supplemental information coder 30, a coding unit multiplexing unit 16, and a stream transmitting unit 32.

The supplemental information coder 30 codes the information items including the 2D/3D identification information input from the supplemental information input terminal 14 when the information is updated, and inputs the coded information to the coding unit multiplexing unit 16.

In addition, the supplemental information coder 30 notifies the video coder 31 and the stream transmitting unit 32 of the completion of the update of the information items including the 2D/3D identification information.

More specifically, in this embodiment, when the video signal to be input to the video transmitting apparatus 10 is switched from 2D to 3D, the completion of the switch is notified to the video coder 31 and the stream transmitting unit 32. In addition, the SEI as the 2D/3D identifier including the 2D/3D identification information is coded.

The video signal to be input to the video transmitting apparatus 10 is, for example, a video signal to be input from the video imaging apparatus 50 via the video input terminal 11.

The video coder 31 compression-codes the output data from the video input unit 12, and outputs the coded data to the coding unit multiplexing unit 16. In addition, when the video coder 31 receives the notification from the supplemental information coder 30, the video coder 31 changes the SPS ID and PPS ID at the time when compression-coding the output data, and generates the data obtained by assigning the SPS and PPS to each of the coded frames.

The coding unit multiplexing unit 16 rearranges the output data from the video coder 31 and the output data from the supplemental information coder 30 in the data order as shown in FIG. 1, and inputs the rearranged data to the stream transmitting unit 32.

In other words, the coding unit multiplexing unit 16 arranges the data generated by the video coder 31 and the supplemental information coder 30 in the order predetermined for each coding unit, and outputs the arranged data. More specifically, at this time, the coded parameter information (the coded SPS and PPS in this embodiment) and the coded supplemental information (the coded SEI in this embodiment) are output according to the arrangement.

The stream transmitting unit 32 generates a coded stream including at least one packet using the data output from the coding unit multiplexing unit 16, and transmits the generated coded stream. More specifically, the stream transmitting unit 32 transmits the coded stream including the packet having the coded parameter information and the coded supplemental information.

In other words, in this embodiment, the stream transmitting unit 32 generates RTP packets each including SEI and either SPS or PPS as shown in FIG. 2 when the stream transmitting unit 32 receives the notification from the supplemental information coder 30. The stream transmitting unit 32 generates the coded stream including the RTP packets, and outputs the generated coded stream.

Here, when a current SEI to be coded includes important SEI such as SEI which is a 2D/3D identifier, it is also good to cause the stream transmitting unit 32 to include the important SEI in an RTP packet including at least one of an SPS and a PPS without fail. In this case, the notification from the supplemental information coder 30 to the stream transmitting unit 32 may be skipped.

SEI is classified into important SEI such as the SEI which is the 2D/3D identifier; and non-important SEI including SEI indicating that decoding and reproducing is possible starting with the frame having the SEI, and SEI indicating the amount of data to be stored in a receiving buffer during a period from when a stream is received to when the decoding of the stream is started.

The supplemental information coder 30 in this embodiment can differently process such important SEI and non-important SEI by notifying the video coder 31 and the stream transmitting unit 32 of the fact that a current SEI to be processed is important SEI only when the current SEI is the important SEI.

The video transmitting apparatus 10 does not always need to include the video input terminal 11 and the video input unit 12. In this case, for example, the video coder 31 may read out a current video signal to be processed from a recording medium (not shown) in the video transmitting apparatus 10.

In addition, the video transmitting apparatus 10 does not always need to include the supplemental information input terminal 14. In this case, for example, the supplemental information coder 30 may detect a switch between 2D and 3D in the video signal by referring to the information indicating a 2D/3D switching timing stored in the video transmitting apparatus 10.

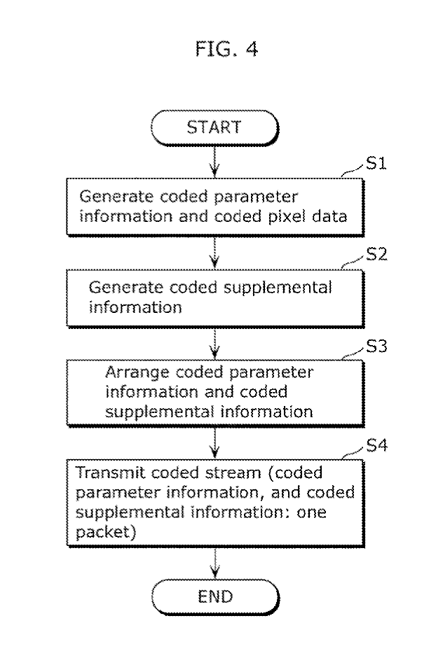

Next, the basic flow of processes performed by the video transmitting apparatus 10 in this embodiment is described with reference to FIG. 4.

FIG. 4 is a flowchart showing a basic flow of processes performed by the video transmitting apparatus 10 according to Embodiment 1 of the present invention.

Here, this processing order shown in FIG. 4 is an example, and thus another processing different from the processing order shown in FIG. 4 may be employed.

The video coder 31 compression-codes a video signal to generate coded parameter information which is parameter information to be used commonly to decode the slices included in at least one coded picture and coded pixel data of the picture (S1). In this embodiment, coded SPS and PPS are generated as such coded parameter information.

The supplemental information coder 30 generates coded supplemental information by coding supplemental information for display control of the video represented by the video signal (S2). In this embodiment, coded SEI is generated as such coded supplemental information.

The coding unit multiplexing unit 16 arranges the data generated by the video coder 31 and the supplemental information coder 30 in the order predetermined for each of coding units, and outputs the arranged data. At this time, the coding unit multiplexing unit 16 disposes the coded supplemental information between the coded parameter information and the coded pixel data, and then outputs them (S3).

The stream transmitting unit 32 generates a coded stream which includes a packet including the coded parameter information and the coded supplemental information using the data received from the coding unit multiplexing unit 16, and transmits the coded stream. The coded pixel data is stored in packets exclusive for the coded pixel data, and is transmitted (S4).

The video transmitting apparatus 10 in this embodiment can transmit a coded stream including RTP packets (see FIG. 2) including SEI, SPS and PPS, and, by performing the aforementioned sequence of processes.

Hereinafter, the processes performed by the video transmitting apparatus 10 are described in detail.

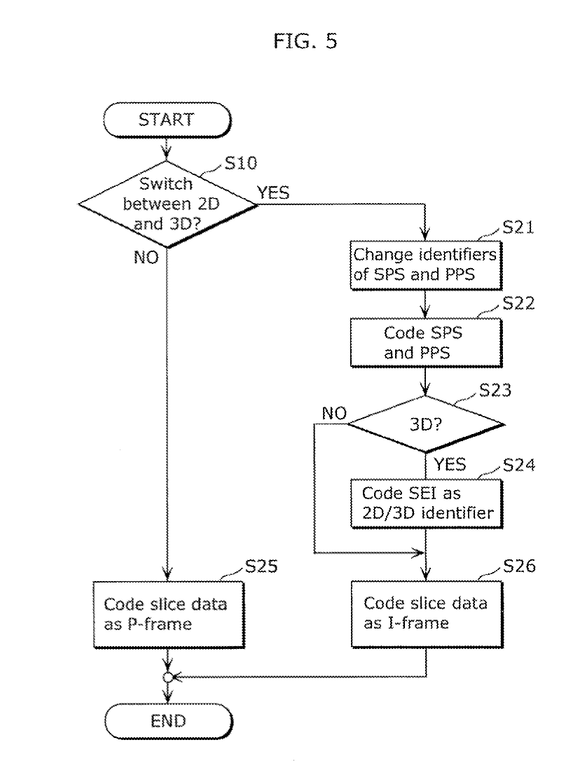

FIG. 5 is a first flowchart of processes of a video coding method in Embodiment 1 of the present invention, and specifically explains the operations performed by the video coder 31 and the supplemental information coder 30.

Here, it is assumed that the display mode of a current frame to be coded by the video coder 31 is switched between 2D and 3D (YES in S10).

For example, when the display mode of the current frame is switched from 2D to 3D and the video coder 31 receives a notification indicating the switch in the form of SEI as a 2D/3D identifier assigned to the current frame included in a sequence of frames from the supplemental information coder 30 (YES in S10), the video coder 31 changes the identifiers of the SPS and PPS (S21).

Here, the old identifiers of the SPS and PPS are examples of first identifiers and the new identifiers thereof are examples of second identifiers.

The video coder 31 further codes the SPS and PPS together with the new identifiers (S22).

Next, when the frame is 3D (YES in S23), the supplemental information coder 30, that is, when the switch is determined to be a switch from 2D to 3D in S10, the supplemental information coder 30 codes the SEI as the 2D/3D identifier (S24). Here, when the frame is 2D (NO in S23), that is, when the switch is determined to be a switch from 3D to 2D in S10, the processing in S24 is skipped.

Next, the video coder 31 codes all the pixel values of the frame as an I-frame on a per slice basis (S26).

When no switch between 2D and 3D is made at a current frame to be coded, for example, when the video coder 31 does not receive any switch notification in a form of SEI as a 2D/3D identifier which is otherwise assigned to the current frame (NO in S10), the video coder 31 codes all the pixel values of the frame as a P-frame on a per slice basis (S25).

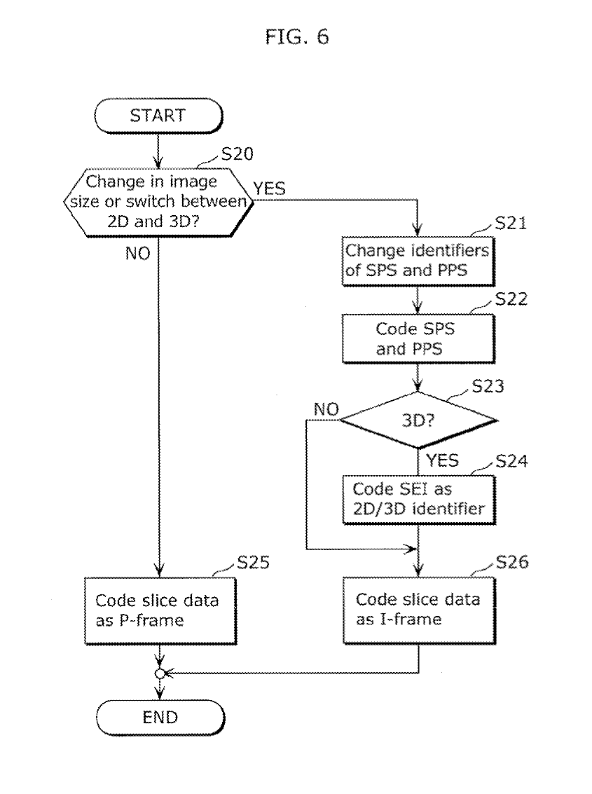

FIG. 6 is a second flowchart of processes of a video coding method according to Embodiment 1 of the present invention.

FIG. 6 shows an exemplary flow of the coding method processes performed by the video imaging apparatus 50 in the cases where a switch to a video signal having a different resolution (for example, from the full high-definition 1920×1080 to a high-definition of 1280×720) is made.

As shown in FIG. 6, the video transmitting apparatus 10 can change the identifiers of the SPS and PPS also when the resolution of the current video signal to be processed is changed, that is, when at least one of the number of horizontal pixels and the number of vertical pixels represented by the video signal is changed. This provides advantageous effects as exemplary indicated below.

Here is provided an exemplary case of a coded stream represented by a video signal having resolutions switched between the first resolution and the second resolution. It is assumed here that an SPS or a PPS corresponding to a slice having a second resolution is lost in the transmission through a network.

In this case, the video receiving apparatus which receives the stream cannot receive the SPS or PPS corresponding to PPS_id which should be referred to in the decoding of the slice. For this reason, erroneous decoding of the slice is prevented.

In other words, the SPS or PPS corresponding to the slice having the first resolution is prevented from being erroneously referred to, which prevents erroneous decoding of the slice having the second resolution. For this reason, the video receiving apparatus can immediately detect the loss of the important data in the transmission through the network.

Accordingly, the video receiving apparatus can issue a notification indicating the loss of the important data to the video transmitting apparatus 10 after the detection of the loss. In response to the notification, the video transmitting apparatus 10 transmits the frame as an I-frame. Upon receiving this, the video receiving apparatus can decode and display the frame correctly.

The video transmitting apparatus 10 operates as specifically indicated below.

It is assumed here that a switch between 20 and 3D or a change in resolution (image size) is made (YES in S20) in a frame to be coded by the video coder 31.

For example, the video coder 31 receives, from the supplemental information coder 30, a notification indicating assignment of 2D/3D identification information to the frame or a notification indicating a change in the image size (YES in S20), the video coder 31 changes the identifiers of the SPS and PPS (S21).

The video coder 31 further codes the SPS and PPS together with the new identifiers (S22).

Next, when the frame is 3D (YES in S23), that is, when the switch is determined to be a switch from 2D to 3D in S10, the supplemental information coder 30 codes the SEI as the 2D/3D identifier (S24).

Here, when the frame is 2D (NO in S23), that is, when the switch is determined to be a switch from 3D to 2D in S20, the processing in S24 is skipped.

Next, the video coder 31 codes all the pixel values of the frame as an I-frame on a per slice basis (S26).

When no switch between 2D and 3D is made at the frame, for example, when the video coder 31 does not receive any switch notification in a form of SEI as a 2D/3D identifier which may be assigned to the frame (NO in S23), the video coder 31 codes all the pixel values of the frame as an I-frame on a per slice basis (S26).

In addition, when no switch between 2D and 3D is made at the frame, specifically when the video coder 31 does not receive, from the supplemental information coder 30, a notification indicating assignment of SEI as a 2D/3D identifier to the frame or a notification indicating a change in the image size (NO in S20), the video coder 31 codes all the pixel values of the frame as a P-frame on a per slice basis (S25).

Here, in each of the flowcharts of FIGS. 5 and 6, for example, a check (S23) on whether a current frame is 2D or 3D is not always necessary. In other words, when the frame is 2D, SEI as a 2D/3D identifier identifying that the frame is 2D may be coded.

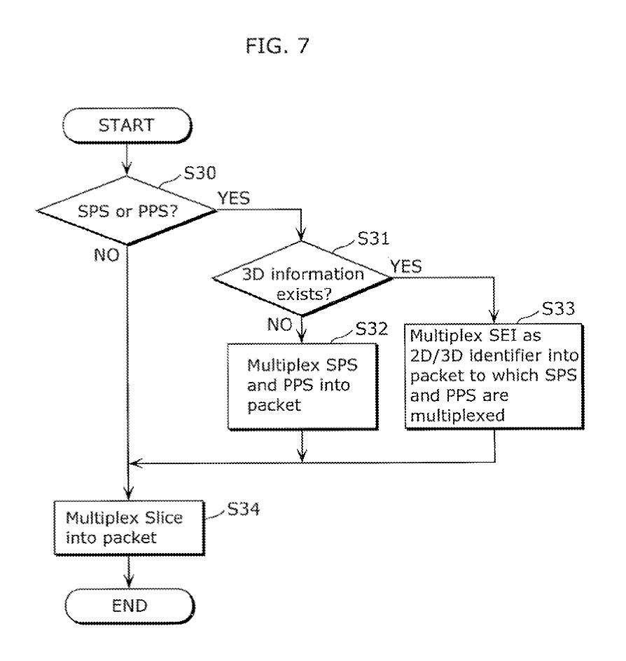

FIG. 7 is a flowchart of processes of an RTP packet generating scheme according to Embodiment 1 of the present invention, and specifically explains operations performed by the stream transmitting unit 32.

The stream transmitting unit 32 receives data arranged in the order predetermined for each of coding units from the coding unit multiplexing unit 16, and determines whether the data to be packetized is one of an SPS and a PPS or not (S30). When the data is determined to be one of an SPS and a PPS (YES in S30), the stream transmitting unit 32 determines whether the data includes SEI and indicates 2D/3D identification information, that is, SEI as a 2D/3D identifier (S31).

When SEI as a 2D/3D identifier is included (YES in S31), the stream transmitting unit 32 stores the SEI as the 2D/3D identifier in a packet including at least one of an SPS and a PPS (S33).

In this embodiment, as shown in FIG. 2, RTP packets each including SEI as a 2D/3D identifier and one of an SPS and a PPS are generated.

When no SEI as a 2D/3D identifier is included (No in S31), the stream transmitting unit 32 generates a packet which includes one of an SPS and a PPS but does not include any SEI as a 2D/3D identifier (S32).

The SPS and PPS may be included in a packet, or may be included in separate packets.

When current data to be processed is neither an SPS nor a PPS (NO in S30), and after S32 and S33 in the case where current data is an SPS or a PPS, the stream transmitting unit 32 packetizes the data of the slices.

Here, it is desirable that a single slice should be packetized into a single packet. However, when the slice data size is comparatively small, a plurality of slices maybe packetized as a packet.

When the slice data size is comparatively large, the slice data may be divided and the resulting slice data portions may be packetized into plural packets.

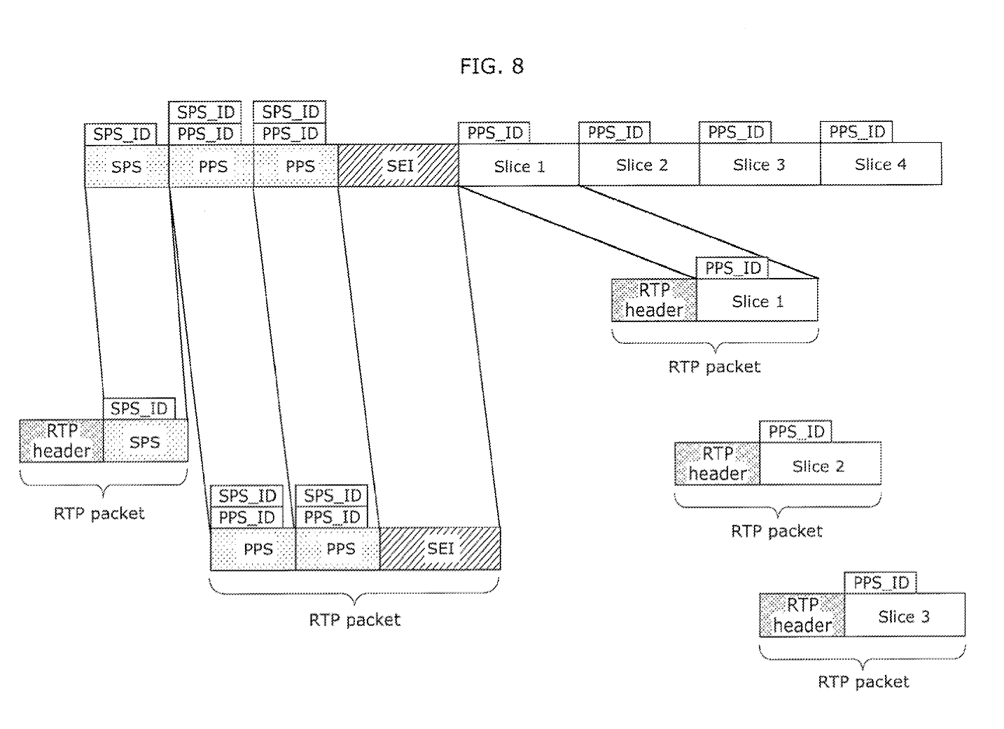

FIG. 8 is a diagram indicating second exemplary RTP packet structures in Embodiment 1 of the present invention. In FIG. 8, an SPS and PPSs are included in separate RTP packets.

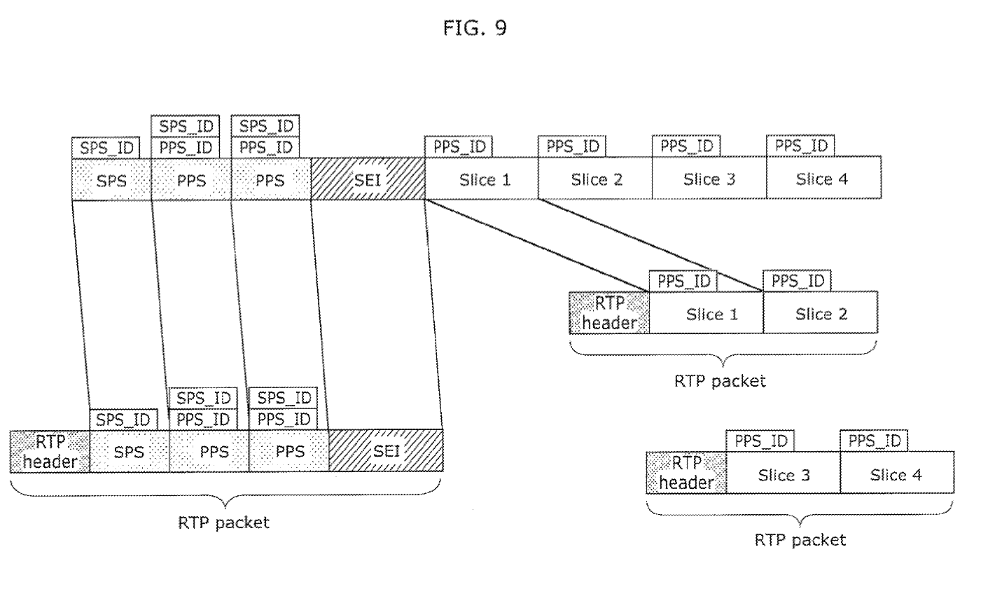

FIG. 9 is a diagram indicating third exemplary RTP packet structures in Embodiment 1 of the present invention, and indicating an example where a plurality of slices is included in each of two of the RTP packets.

Although two slices are included in each of the two RTP packets in FIG. 9, three or more slices may be included in each of the two RTP packets.

In addition, the information which is supplemental information for an image and included in SEI does not always need to be 2D/3D identification information, and may be position information for a video in the case where the video includes the plurality of videos synthesized thereto.

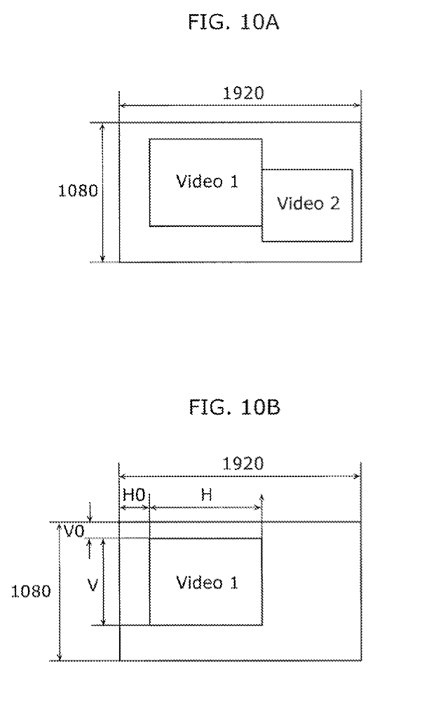

FIG. 10A is a schematic diagram showing a video in which two videos are synthesized. In other words, FIG. 10A is an example of displaying the video as a result of decoding and reproducing the video signal representing two or more videos which can be displayed in parallel in a single frame area.

FIG. 106 is a schematic diagram showing a case where only one of the two videos shown in FIG. 10A is extracted and displayed, and FIG. 10C is a schematic diagram showing a case where the other one of the two videos shown in FIG. 10A is extracted and displayed.

A case shown in FIG. 10A is assumed here. In this case, a video in which a video 1 and a video 2 are synthesized is transmitted from the video transmitting apparatus 10. When a user of the video receiving apparatus wishes to view only the video 1 in this case, with the knowledge of the positions of the video 1 and video 2 in the frame area, the video receiving apparatus can, for example, extract only the video 1 and enlarge and/or display the video 1.

For this reason, the video transmitting apparatus 10 codes SEI including the position information of the video 1 and the video 2.

In this way, the video receiving apparatus extracts and reproduces the video 1 and the video 2 by referring to the SEI indicating the position information (hereinafter referred to as “SEI as position information”) when decoding and reproducing the received coded stream.

More specifically, information as indicated below is included in SEI as position information of the video 1 and video 1.

The supplemental information coder 30 includes H, V, H0, and V0 shown in FIG. 10B as position information items of the video 1 in SEI as position information. In addition, the supplemental information coder 30 includes h, v, h0, and v0 shown in FIG. 10C as position information items of the video 2 in SEI as position information. The supplemental information coder 30 codes the SEI as the position information including the position information items of the video 1 and the position information items of the video 2.

In other words, the information items indicating the width, height, and the upper-left coordinates of each of the video 1 and video 2 are shown by the SEI as the position information.

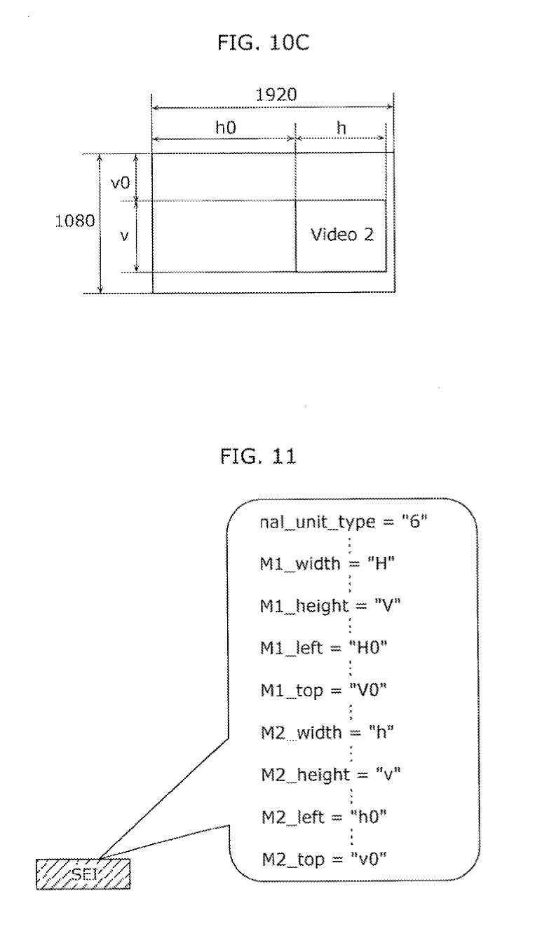

FIG. 11 is a diagram showing an exemplary data structure of part of SEI as position information according to Embodiment 1 of the present invention.

In the SEI as the position information shown in FIG. 11, “nal_unit_type=“6”” shows that the information is SEI, and thereafter the information items indicating the width, height, and upper-left coordinates of each of the video 1 (M1) and video 2 (M2) are stored.

In other words, the position information SEI is an example of supplemental information indicating that the video corresponding to the position information SEI is not a normal video (a first video) indicating a single video but a video (a second video) indicating two videos as shown in FIG. 10A.

The stream transmitting unit 32 regards, as important SEI, the SEI as the position information including the aforementioned information items, and includes the SEI as the position information into a packet including an SPS or a PPS. Furthermore, the stream transmitting unit 32 transmits the coded stream including the packet in the network.

In this case, when the SEI as the position information is lost in the network, the PPS or SPS is also lost. Thus, the video receiving apparatus can detect the loss of the SEI as the position information. In other words, the video receiving apparatus can detect, as an error, the loss of the SEI as the position information.

In this way, the video receiving apparatus can request the video transmitting apparatus 10 to retransmit the frame corresponding to the SEI as the position information.

As a result, the video receiving apparatus can receive the I-frame having the SEI as the position information transmitted from the video transmitting apparatus 19. Thus, for example, the video receiving apparatus can extract and reproduce each of the video 1 and the video 2 by referring to the SEI as the position information.

A case is assumed in which SEI as position information must be assigned. As such an exemplary case, it is assumed that a current video signal to be processed by the video transmitting apparatus 10 is switched from a normal video signal representing a single video to a video signal representing two videos as shown in FIG. 10A.

Also in this case, the identifiers of the SPS and PPS may be changed (see S21 in FIG. 5) as in the case of a switch from 2D to 3D.

In addition, the identifiers of the SPS and PPS may be changed also when there is an update in the SEI as the position information, for example, when there is a change in the positions and sizes of the two videos.

In this way, changing the identifiers of the SPS and PPS provides advantageous effects as described blow.

As such an exemplary case, it is assumed that a current video signal to be decoded by the video receiving apparatus is switched from a normal video signal representing a single video to a video signal representing two videos as shown in FIG. 10A. It is also assumed that, in this case, the SPS and PPS that should be referred to in the decoding of the later-type video signal were lost in the transmission through the network.

In this case, in response to the switch in the types of the video signals, the identifiers of the SPS and PPS are changed. For this reason, the PPS including PPS_ID identical to the PPS_ID assigned to the slice included in the later-type video signal is not present in the video receiving apparatus.

In other words, there is no possibility that the slice is decoded with reference to an erroneous SPS or PPS previously received. For this reason, the video receiving apparatus can immediately detect the loss of the important data in the transmission through the network.

As described above, the video transmitting apparatus 10 in this embodiment generates a coded stream which includes a packet including the coded parameter information (such as coded PPS) and coded supplemental information (coded SEI as a 2D/3D identifier).

This suppresses increase in the amount of data, and makes it possible to transmit a coded stream having a high error resilience.

### Embodiment 2

Next, Embodiment 2 is described below.

Here, a program for implementing the video transmitting method described in Embodiment 1 is recorded onto a recording medium such as a flexible disc. In this way, the processes described in Embodiment 1 can be easily executed in an independent computer system.

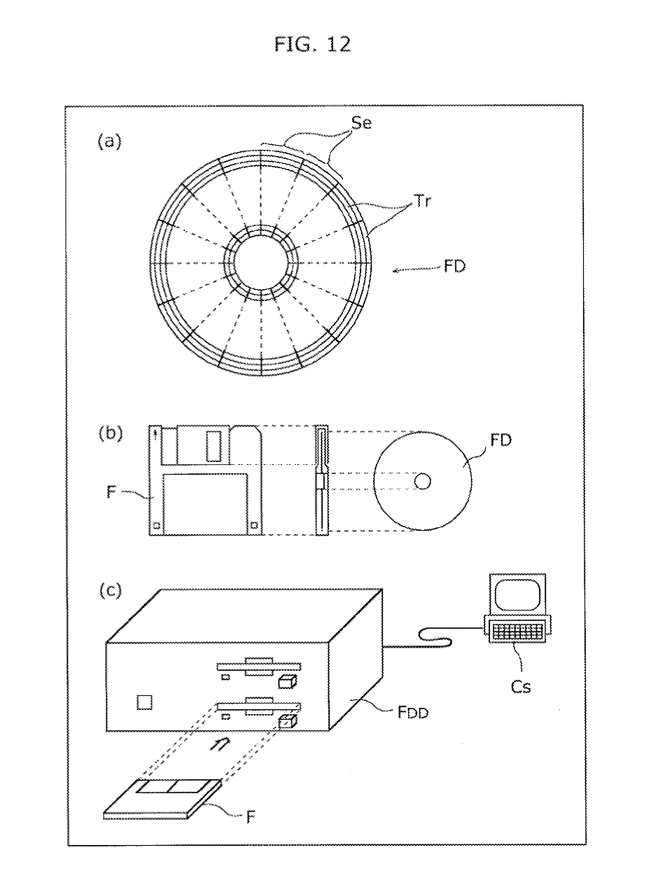

FIG. 12 includes illustrations for explaining a case where a computer system executes the video transmitting method in Embodiment 1, using the program recorded on a recording medium such as a flexible disc.

In FIG. 12, (a) shows an example of a physical format of the flexible disc which is a recording medium body, and (b) shows the front view of the recording medium, the cross-sectional view of the appearance of the flexible disc, and the flexible disc.

The flexible disc FD is contained in a case F, a plurality of tracks Tr are formed concentrically on the surface of the disc from the periphery into the inner radius of the disc, and each track is divided into 16 sectors Se in the angular direction. Therefore, in the case of the flexible disc storing the above-mentioned program, the program is recorded in an area allocated for it on the flexible disc FD.

In addition, (c) in FIG. 14 shows the structure for recording and reproducing the program on the flexible disc FD. When the program for implementing a video transmitting method is recorded on the flexible disc FD, the computer system Cs writes the program via a flexible disc drive.

In addition, when the video transmitting method is configured in the computer system Cs by the program recorded on the flexible disc, the program is read out from the flexible disc through the flexible disc drive and is transferred to the computer system.

It is to be noted that the above description is given assuming that the recording medium is a flexible disc, but an optical disc can be used instead. In addition, the recording medium is not limited to such a flexible disc, and any other recording media such as IC cards and ROM cassettes and the like that can record the program can also be used for the implementation.

Furthermore, the functional blocks (see FIG. 3) of the video transmitting apparatus 10 in Embodiment 1 are typically implemented in the form of an LSI or LSIs. Some or all of these functional blocks may be integrated into a single chip, or the respective functional blocks maybe implemented as separate chips. For example, the functional blocks other than the memory may be integrated into a single chip.

It is to be noted that each of the integrated circuits used here is called LSI, but it may also be called IC, system LSI, super LSI, or ultra LSI depending on the degree of integration.

Moreover, ways to achieve integration are not limited to the LSIs, and special circuits or general purpose processors and so forth can also achieve the integration. A field programmable gate array (FPGA) that can be programmed after manufacturing an LSI or a reconfigurable processor that allows re-configuration of the connection or settings of the circuit cells inside the LSI can be used.

Furthermore, when advanced semiconductor technology or technology derived therefrom is applied to a technique of manufacturing integrated circuits which replace LSIs in the future, the functional blocks may be integrated using the technique as a matter of course. Application of biotechnology is one such possibility. Also in such a case, it is possible to regard, as a separate element, a means for storing data targeted in the video transmitting method from among the functional blocks, and not to integrate the storage means into a chip to which the remaining functional blocks are integrated.

In other words, the respective structural elements in Embodiment 1 may be implemented as exclusive hardware, or implemented by executing one or more software programs suitable for the structural elements. Alternatively, the structural elements may be implemented by means of the program executing unit such as a CPU and a processor reading out and executing one or more software programs recorded on a recording medium such as hard disk and a semiconductor memory. Here, the software which implements the video transmitting apparatus 10 in Embodiment 1 is such a program as indicated below.

More specifically, the program causing a computer to execute the video transmitting method indicated below.

The video transmitting method includes compression-coding a video signal to generate coded parameter information and coded pixel data, the coded parameter information being parameter information commonly used to decode slices included in at least one picture, and the coded pixel data being of the picture; coding supplemental information for controlling display of a video represented by the video signal to generate coded supplemental information; outputting, in order predetermined for each of coding units, the coded parameter information generated by the video coder and the coded supplemental information generated by the supplemental information coder; and generating a coded stream including a packet which includes the coded parameter information and the coded supplemental information, using data output from the coding unit multiplexing unit, and transmitting the generated coded stream.

Although the video transmitting apparatus and the video transmitting method according to some aspects of the present invention have been described in the above embodiments, the present invention is not limited to the above embodiments. All embodiments obtainable by modifying these exemplary embodiments and arbitrarily combining the structural elements of different embodiments are included in the scope of the present invention unless the embodiments materially depart from the principles and spirit of the present invention.

For example, although each of FIG. 2 and FIG. 11 shows an exemplary SEI data structure, any other SEI data structures are possible as long as these data structures enable identification of the necessary information such as information indicating whether the video signal corresponding to the SEI is 2D or 3D.

In addition, the video transmitting apparatus 10 in Embodiment 1 generates an RTP packet including SEI and at least one of a PPS and an SPS. However, the types of packets generated by the video transmitting apparatus 10 are not limited to particular ones. In other words, the video transmitting apparatus 10 suppresses increase in the amount of data of even packets other than RTP packets and can generate a coded stream having a high error resilience as long as the coded stream is transmitted on a per packet basis according to a connectionless protocol.

### INDUSTRIAL APPLICABILITY

The present invention makes it possible to easily implement a video transmitting apparatus which stores information items such as 2D/3D identification information important in display control into packets including SPSs and PPSs, and transmits the packets, and thus is robust to losses of packets transmitted in networks. For this reason, the present invention is applicable to communication apparatuses and set apparatuses which code videos, represented by apparatuses which perform bi-directional video communication or video distribution using networks and monitoring cameras.

### REFERENCE SIGNS LIST

10,100 Video transmitting apparatus
11,111 Video input terminal
12,112 Video input unit
14,114 Supplemental information input terminal
16,116 Coding unit multiplexing unit
30,115 Supplemental information coder
31,113 Video coder
32,117 Stream transmitting unit
50 Video imaging device
120 Input terminal
121 Stream receiving unit
122 Packet demultiplexing unit
123 Video decoder
124 Supplemental information decoder
125 Display control unit
126 Video display unit
127 Video output terminal
128 Video display device
200 Video receiving apparatus

1. A video transmitting apparatus comprising:
a video coder configured to compression-code a video signal to generate coded parameter information and coded pixel data, the coded parameter information being parameter information commonly used to decode slices included in at least one picture, and the coded pixel data being of the picture;
a supplemental information coder configured to code supplemental information for controlling display of a video represented by the video signal to generate coded supplemental information;
a coding unit multiplexing unit configured to output, in order predetermined for each of coding units, the coded parameter information generated by the video coder and the coded supplemental information generated by the supplemental information coder; and
a stream transmitting unit configured to generate a coded stream including a packet which includes the coded parameter information and in which the coded supplemental information is surely included, using data output from the coding unit multiplexing unit, and transmit the generated coded stream.

2. The video transmitting apparatus according to claim 1,
wherein the supplemental information indicates whether the video represented by the video signal is a first video or a second video, the first video and the second video having different display modes, and
the video coder is configured to:
generate the coded parameter information and the coded pixel data which have a first identifier assigned, when the video signal is the first video; and
generate the coded parameter information and the coded pixel data having a second identifier assigned, when the video signal represents the second video, the second identifier being different from the first identifier.

3. The video transmitting apparatus according to claim 1,
wherein the supplemental information indicates whether the video represented by the video signal is a first video or a second video, the first video and the second video having different display modes,
when the video represented by the video signal is switched from one of the first video and the second video to the other, the supplemental information coder is configured to generate coded supplemental information indicating the other of the first video and the second video, and
the video coder is configured to generate the coded parameter information, when the coded supplemental information indicating the other of the first video and the second video is generated.

4. The video transmitting apparatus according to claim 1,
wherein the stream transmitting unit is configured to generate, for each of sequences of a plurality of pictures represented by the video signal, the coded stream including the packet which includes the coded parameter information and the coded supplemental information corresponding to the plurality of pictures.

5. The video transmitting apparatus according to claim 1,
wherein the supplemental information is identification information indicating that a display mode of the video represented by the video signal is 3D.

6. The video transmitting apparatus according to claim 1,
wherein a display mode of the video represented by the video signal is three-dimensional (3D), and
the supplemental information is identification information for identifying a transmission scheme for the video signal.

7. The video transmitting apparatus according to claim 1,
wherein the video signal is a signal representing at least two videos which can be displayed in parallel in a frame area, and
the supplemental information is position information indicating positions of the at least two videos in the frame area.

8. The video transmitting apparatus according to claim 1,
wherein the video coder is configured to generate the coded parameter information when at least one of the number of horizontal pixels and the number of vertical pixels of the video represented by the video signal is changed.

9. The video transmitting apparatus according to claim 1,
wherein the parameter information includes at least one of a Sequence Parameter Set (SPS) and a Picture Parameter Set (PPS).

10. A video transmitting method comprising:
compression-coding a video signal to generate coded parameter information and coded pixel data, the coded parameter information being parameter information commonly used to decode slices included in at least one picture, and the coded pixel data being of the picture;
coding supplemental information for controlling display of a video represented by the video signal to generate coded supplemental information;
outputting, in order predetermined for each of coding units, the coded parameter information generated by the video coder and the coded supplemental information generated by the supplemental information coder; and
generating a coded stream including a packet which includes the coded parameter information and in which the coded supplemental information is surely included, using data output from the coding unit multiplexing unit, and transmitting the generated coded stream.

11. A non-transitory computer-readable recording medium having a program recorded thereon for coding a video signal to generate a coded stream and transmitting the coded stream, the program causing a computer to execute:
compression-coding a video signal to generate coded parameter information and coded pixel data, the coded parameter information being parameter information commonly used to decode slices included in at least one picture, and the coded pixel data being of the picture;
coding supplemental information for controlling display of a video represented by the video signal to generate coded supplemental information;
outputting, in order predetermined for each of coding units, the coded parameter information generated by the video coder and the coded supplemental information generated by the supplemental information coder; and
generating a coded stream including a packet which includes the coded parameter information and in which the coded supplemental information is surely included, using data output from the coding unit multiplexing unit, and transmitting the generated coded stream.

12. An integrated circuit comprising:
a video coder configured to compression-code a video signal to generate coded parameter information and coded pixel data, the coded parameter information being parameter information commonly used to decode slices included in at least one picture, and the coded pixel data being of the picture;
a supplemental information coder configured to code supplemental information for controlling display of a video represented by the video signal to generate coded supplemental information;
a coding unit multiplexing unit configured to output, in order predetermined for each of coding units, the coded parameter information generated by the video coder and the coded supplemental information generated by the supplemental information coder; and
a stream transmitting unit configured to generate a coded stream including a packet which includes the coded parameter information and in which the coded supplemental information is surely included, using data output from the coding unit multiplexing unit, and transmit the generated coded stream.
